(19) United States
(12) Patent Application Publication
(10) Pub. No.: US 2026/0086847 A1
(43) Pub. Date: Mar. 26, 2026

(54) CONTAINER MIGRATION FOR UPDATES IN DISTRIBUTED COMPUTING ENVIRONMENTS

(71) Applicant: Red Hat, Inc., Raleigh, NC (US)

(72) Inventors: Leigh Griffin, Waterford (IE); Pierre-Yves Chibon, Puteaux (FR); Brian Exelbierd, Brno (CZ)

(73) Assignee: Red Hat, Inc., Raleigh, NC (US)

(21) Appl. No.: 18/898,375

(22) Filed: Sep. 26, 2024

(51) Int. Cl. G06F 9/48; G06F 8/65

(52) U.S. Cl. CPC G06F 9/4856; G06F 8/65

(57) ABSTRACT

Techniques described herein relate to performing container migration for updates in a distributed computing environment. For example, an update to a container executing on a first node of a plurality of nodes in a distributed computing environment can be received. One or more services may be deployed in the container. In response to receiving the update, a resource requirement for executing the one or more services can be determined. A second node can be identified that meets the resource requirement for executing the one or more services. Prior to updating the container, execution of the one or more services can be migrated to the second node. Subsequent to updating the container, execution of the one or more services can be migrated back to the updated container.

### TECHNICAL FIELD

The present disclosure relates generally to distributed computing environments. More specifically, but not by way of limitation, this disclosure relates to container migration for updates in distributed computing environments.

### BACKGROUND

To help automate the deployment, scaling, and management of software resources inside containers, some distributed computing environments may include container orchestration platforms. Container orchestration platforms can help manage containers to reduce the workload on users. One example of a container orchestration platform is Kubernetes. Distributed computing environments running Kubernetes can be referred to as Kubernetes environments.

A container is a relatively isolated virtual environment created by leveraging the resource isolation features (e.g., cgroups and namespaces) of the Linux Kernel. Deploying software services inside containers can help isolate the software services from one another, which can improve speed and security and provide other benefits. Containers are deployed from image files using a container engine, such as Docker®. These image files are often referred to as container images. A container image can be conceptualized as a stacked arrangement of layers in which a base layer is positioned at the bottom and other layers are positioned above the base layer. The other layers may include a target software service and its dependencies, such as its libraries, binaries, and configuration files. The target software service may be configured to run (e.g., on a guest operating system) within the isolated context of the container.

### BRIEF DESCRIPTION OF THE DRAWINGS

FIG. 1 is a block diagram of an example of a distributed computing environment involving container migration for updates, according to some aspects of the present disclosure.

FIG. 2 is a block diagram of another example of a distributed computing environment including container migration for updates, according to some aspects of the present disclosure.

FIG. 3 is a block diagram of another example of a distributed computing environment including container migration for updates, according to some aspects of the present disclosure.

FIG. 4 is a flowchart of an example of a process for implementing container migration for updates in a distributed computing environment, according to some aspects of the present disclosure.

### DETAILED DESCRIPTION

Image-based operating systems may require a reboot to perform updates. For instance, an update can be downloaded onto a running system, but may only become effective once the system has been restarted. Thus, restarts for updates can cause outages and disruptions to services executing on the system. In some instances, when a system is restarted, some nodes may have difficulty coming back online. This may particularly occur in edge computing environments with remote edge nodes. If a network connection is disrupted for an edge node, it may be difficult or impossible to reestablish communication with the edge node. Or, in some instances, the update may be a bad update and may prevent a system from coming back online or resuming execution of services. Therefore, it may be beneficial to reduce downtime, minimize outages, and maintain continuity of execution of services in distributed computing environments.

Some examples of the present disclosure can overcome one or more of the issues mentioned above by using a container migration coordinator that can migrate execution of services from a container that is to be updated to another node in a distributed computing environment. When an update is pushed for the container, the container migration coordinator can analyze the workload of the container, temporarily migrate execution of that workload elsewhere in the distributed computing environment without ceasing execution of the workload, and only then push the update to the container. After the container has updated and restarted, the workload (e.g., execution of the services) can be migrated back to the updated container. In this way, containers can be updated and restarted while maintaining continuous execution of services. Further, if the update causes an issue with the container or the container does not properly restart, the services can continue executing on the nodes to which they were migrated.

In a particular example, a container management orchestration system such as Kubernetes can deploy and manage containers on nodes of a mesh. The container management orchestration system can include a container migration coordinator that can have visibility over the running containers in the mesh. Services can be deployed in each of the containers. When an update is staged for a particular container, the container migration coordinator can temporarily migrate a workload running in the particular container to another computing resource thereby allowing the particular container to available for a reboot without service interruption.

For example, upon receiving the update, the container migration coordinator can automatically evaluate the workload for the particular container to determine a resource requirement for the workload (e.g., executing the services deployed in the particular container). The container migration coordinator may first identify the services deployed in the particular container. For example, the container migration coordinator may access a specification file for the particular container. The specification file may outline the services deployed in the particular container as well as minimum resource requirements for executing the services. Additionally or alternatively, the container migration coordinator may determine the resource requirement by evaluating the computing resources consumed by the container executing the services, such as random-access memory (RAM), central processing unit (CPU) usage, etc. For example, the container migration coordinator may determine an average amount of RAM and CPU consumed by the container.

After determining the resource requirement for the particular container (e.g., the amount of RAM, CPU, or any other suitable computing resources needed to execute the services deployed on the particular container), the container migration coordinator can identify another node in the mesh that can meet the resource requirement. The other node may, for example, be a bare metal node, another container, a virtual machine, an Internet of Things node, an edge node, a cloud node, or any other suitable node in the mesh that meets the resource requirement. The container migration coordinator can migrate the workload of the particular container to the identified node. For example, the container migration coordinator can migrate the storage volumes used by the container to the identified node. Then, the container image can be migrated to the identified node. Meanwhile, the container migration coordinator can keep a local record of what components were migrated to which locations. The container migration coordinator can trigger startup of the services in the identified node, as well as updating the routing rules in the mesh to reroute traffic to the identified node. In some examples, techniques such as A/B failover techniques may be used to migrate the workload to the identified node. In this way, the services can continuously execute without interruption.

The particular container may only be updated and restarted after its workload has successfully been migrated to the identified node. For example, after the container migration coordinator confirms that the workload has successfully been migrated, execution of the particular container can be terminated. The update and restart can then be performed on the particular container. Once the particular container has been restarted, the container migration coordinator can validate the updated coordinator. If validated, the container migration coordinator can perform the migration steps in reverse to migrate the workload on the identified node back to the updated container (including, in some examples, A/B failover techniques). If not validated, for example if the container loses network connection with the mesh, the workload may continue executing on the identified node.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

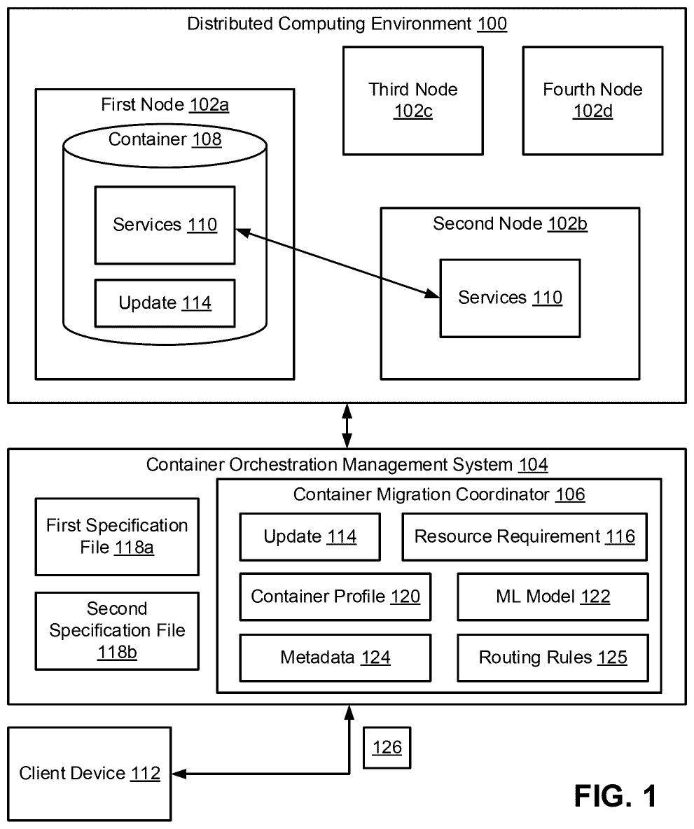

FIG. 1 is a block diagram of an example of a distributed computing environment 100 involving container migration for updates, according to some aspects of the present disclosure. In some examples, the distributed computing environment 100 can include multiple devices (e.g., nodes 102a-d) in communication via a network, such as a local area network or the Internet. The nodes 102a-d can execute services that can, for example, fulfill requests 126 transmitted by a client device 112. For example, a first node 102a can include a container 108. Services 110 can be deployed within the container 108. A container orchestration management system 104, such as Kubernetes, can deploy and manage containers in the distributed computing environment 100. The container orchestration management system 104 can include a container migration coordinator 106 that can handle migration of container workloads to enable updates.

For example, the container orchestration management system 104 can receive an update 114 for the container 108. Applying the update 114 may require restarting the first node 102a. To maintain continuous execution of the services 110 without downtime or service outages, the container migration coordinator 106 can automatically start a process that migrates the services 110 to one of the other nodes. For example, the container migration coordinator 106 can identify the workload for the container 108. In some examples, the container migration coordinator 106 can access a first specification file 118a for the container 108 to identify the services 110. The first specification file 118a can also specify any data sources, such as persistent volumes, used by the services 110. The first specification file 118a may also, in some examples, include annotations that specify minimum resource requirements for executing the services 110. After identifying the services 110, the container migration coordinator 106 can determine a resource requirement 116 for executing the services 110. The resource requirement 116 can be based on the information specified in the first specification file 118a. Additionally or alternatively, the container migration coordinator 106 can probe the container 108 to determine the resource requirement 116.

For example, the container migration coordinator 106 may include profiling tools that can generate a container profile 120 for the container 108 over time (e.g., taking benchmark measurements at particular intervals). The container profile 120 can indicate typical computing resource consumption at particular times. For example, the container profile 120 may indicate that network traffic (e.g., from client device 112) and therefore computing resource consumption is highest on particular days or particular times of day. In some examples, the container migration coordinator 106 may execute a machine learning (ML) model 122 that can generate the container profile 120. Thus, the container migration coordinator 106 may determine the resource requirement 116 based on the container profile 120. In some examples, the resource requirement 116 may also depend on a predicted amount of time involved in performing the update 114. For example, if the update 114 is predicted to take several hours, including the hour of typical peak traffic for the container 108, the resource requirement 116 may be relatively higher in order to ensure continuity of execution of the services 110 during the peak traffic hour.

After determining the resource requirement 116, the container migration coordinator 106 can determine another node in the distributed computing environment 100 that meets the resource requirement 116. In some examples, the container migration coordinator 106 can select a node by using the ML model 122. For example, the resource requirement 116, the services 110, node information for the other nodes, etc., can be input into the ML model 122. The ML model 122 can generate, based on the input, a recommendation for a particular node, such as second node 102b, to which the services 110 should be migrated. In other examples, the container migration coordinator 106 can evaluate the available resources of the other nodes to select a node for migration, such as available storage, RAM, CPU, networking capabilities, etc. The available resources may include both hardware resources and software resources. For example, if one of the services 110 is a Java-based application, the container migration coordinator 106 may select a Java-supported node, such as the second node 102b. In some examples, the container migration coordinator 106 can select the second node 102b based in part on a second specification file 118b for the second node 102b (or a container executing on the second node 102b).

To migrate the services 110 to the second node 102b, the container migration coordinator 106 can first move any storage volumes (e.g., persistent volumes) of data used by the services 110 to the second node 102b, as well as any context for executing the services 110. Then, the container migration coordinator 106 can migrate an image file for the services 110 (or, in some examples, a container image for the container 108). In some examples, the container migration coordinator 106 can utilize failover techniques, such as A/B failover, to migrate the data and image files to the second node 102b. The container migration coordinator 106 can store metadata 124 indicating the original storage locations of storage volumes, services, etc., and the migration locations (e.g., in the second node 102b) to which the storage volumes and services 110 are migrated.

Once migration is confirmed successful, the container migration coordinator 106 can trigger execution of the services 110 (or deployment of a container that executes the services 110) on the second node 102b. The container migration coordinator 106 can also update routing rules 125 for traffic to the services 110. For example, the routing rules 125 can be updated to reroute requests 126 from the client device 112 to the second node 102b instead of the first node 102a. Thus, execution of the services 110 can continue without interruption. The container migration coordinator 106 may only terminate execution of the services 110 and/or the container 108 on the first node 102a after the services 110 successfully execute on the second node 102b.

Once terminated, the container migration coordinator 106 can push the update 114 to the container 108. After the update 114 is downloaded, the container 108 may be required to restart. Restarting the container 108 may not affect execution of the services 110, which are now executing on the second node 102b. The container migration coordinator 106 may validate whether the container 108 successfully updated and restarted. For example, the container migration coordinator 106 may attempt to reestablish network connection with the first node 102a and the container 108. In some examples, particularly in edge computing, there may be a risk of edge nodes failing to restart properly. If the container 108 fails to restart, the container migration coordinator 106 may not attempt to migrate the services 110 back to the first node 102a.

If the container migration coordinator 106 validates that the container 108 has successfully updated and restarted, migration of the services 110 back to the container 108 can be automatically initiated. The services 110 can be migrated back to the first node 102a from the second node 102b in the same manner as before (e.g., using failover techniques such as A/B failover), but in reverse. For example, the container migration coordinator 106 can access the metadata 124 to determine storage volumes, data, and other context to copy over to the container 108 on the first node 102a. Then, image files for the services 110 can be moved to the container 108. The container migration coordinator 106 can validate that all files and data have been successfully migrated to the first node 102a before starting up execution of the services 110 on the first node 102a and terminating execution of the services 110 on the second node 102b. Additionally, the container migration coordinator 106 can update the routing rules 125 to route requests 126 from the client device 112 to the first node 102a instead of the second node 102b.

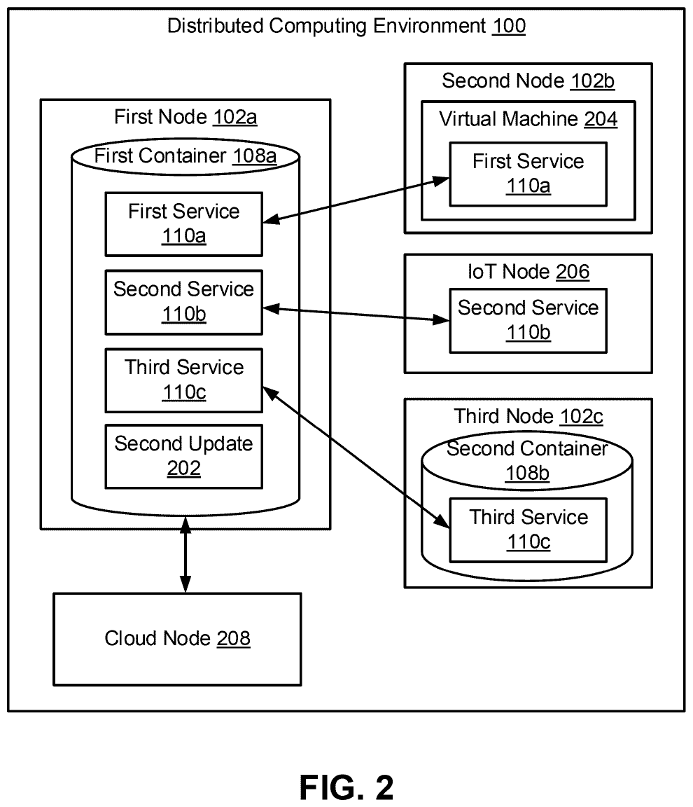

In some examples, as depicted in FIG. 2, the container migration coordinator 106 may not identify any node in the distributed computing environment 100 that meets the resource requirement 116 for executing the services 110. FIG. 2 is a block diagram of another example of the distributed computing environment 100 including container migration for updates, according to some aspects of the present disclosure. In FIG. 2, the first node 102a may include a first container 108a in which three services 110a-c are deployed. A second update 202 may need to be applied to the first container 108a. The distributed computing environment 100 may include a second node 102b on which a virtual machine 204 is executing, an Internet of Things (IoT) node 206, and a third node 102c. None of the second node 102b, third node 102c, or the IoT node 206 meet the resource requirement for executing the services 110a-c. For example, the second node 102b may have the necessary software requirements but may lack hardware requirements or storage space.

In cases where a single node does not meet the resource requirement for executing the services 110a-c deployed on the first container 108a, a container migration coordinator (e.g., the container migration coordinator 106 of FIG. 1) may identify multiple nodes in the distributed computing environment 100 that can split the workload of the first container 108a. For example, the services 110a-c can be split into different sets that can be migrated to different nodes in the distributed computing environment 100. Each subset of services can be evaluated to determine their respective resource requirements, and one or more nodes can be selected that meet the resource requirements for the subset.

In the example depicted in FIG. 2, the first service 110a can be migrated to the virtual machine 204 running on the second node 102, the second service 110b can be migrated to the IoT node 206 (e.g., to run directly on the node itself), and the third service 110c can be migrated into a second container 108b running on the third node 102c. Any combination of services 110a-c can be migrated to any combination of nodes according to resource requirements, such as a first set of services including the first service 110a and second service 110b being migrated to the second node 102b and the third service 110c being migrated to the IoT node 206. In some examples, storage volumes for a service, such as the first service 110a, may be stored on a separate node than the node to which the first service 110a is executed. For example, the first service 110a may be migrated to the virtual machine 204, while data in a storage volume for the first service 110a may be migrated to the second container 102b.

Additionally or alternatively, if there are no single nodes in the distributed computing environment 100 that meet the resource requirements for the services 110a-c, the container migration coordinator 106 can cause a cloud node 208 to be instantiated that meets the resource requirements. Some or all of the services 110a-c can be migrated to the cloud node 208.

While FIGS. 1-2 depicts a specific arrangement of components, other examples can include more components, fewer components, different components, or a different arrangement of components than is shown in FIGS. 1-2. For example, the distributed computing environment 100 can include more or fewer nodes 102a-d, more or fewer containers 108a-b, virtual machines, IoT nodes, cloud nodes, etc. Additionally, any component or combination of components depicted in FIGS. 1-2 can be used to implement the process(es) described herein. Additionally, although examples described herein are directed to container migration, techniques may similarly and equivalently apply to virtual machine migration for updates.

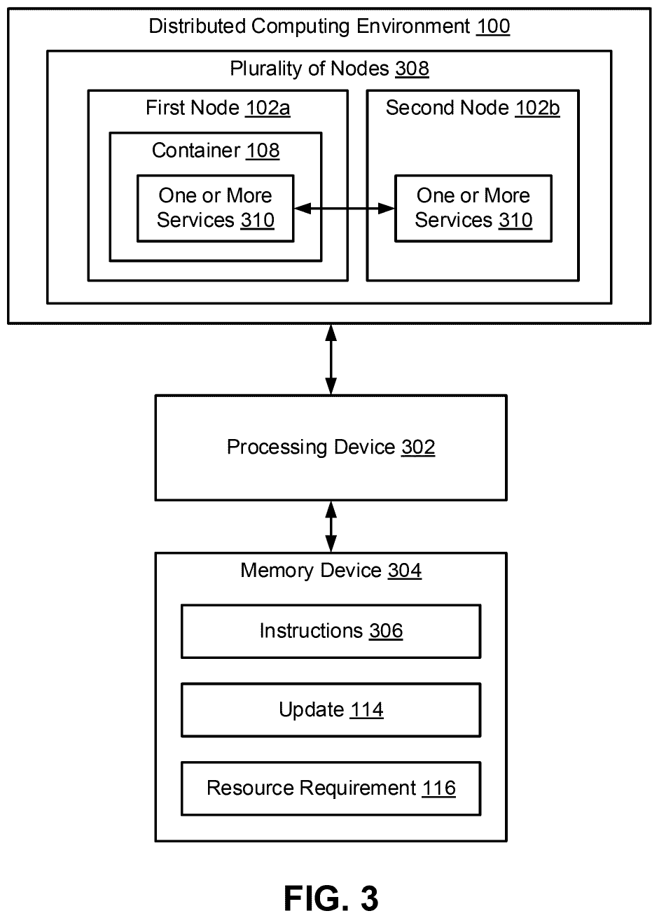

FIG. 3 is a block diagram of another example of a distributed computing environment 300 including container migration for updates, according to some aspects of the present disclosure. The distributed computing environment 300 depicted in FIG. 3 includes a processing device 302 communicatively coupled with a memory device 304. In some examples, the components of the computing environment 300, such as the processing device 302 and the memory device 304, may be part of a same computing device. In other examples, the processing device 302 and the memory device 304 can be included in separate computing devices that are communicatively coupled.

The processing device 302 can include one processing device or multiple processing devices. Non-limiting examples of the processing device 302 include a Field-Programmable Gate Array (FPGA), an application-specific integrated circuit (ASIC), a microprocessor, etc. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C #, etc.

The memory device 304 can include one memory or multiple memories. The memory device 304 can be non-volatile and may include any type of memory that retains stored information when powered off. Non-limiting examples of the memory device 304 include electrically erasable and programmable read-only memory (EEPROM), flash memory, or any other type of non-volatile memory. At least some of the memory can include a non-transitory computer-readable medium from which the processing device 302 can read instructions 306. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions 306.

In some examples, the processing device 302 can execute the instructions 306 to perform some or all of the functionality described herein. For example, the processing device 302 can receive an update 114 to a container 108 executing on a first node 102a of a plurality of nodes 308 in a distributed computing environment 100. One or more services 310 can be deployed in the container 108. The processing device 302 can, in response to receiving the update 114, determine a resource requirement 116 for executing the one or more services 310. The processing device 302 can identify a second node 102b that meets the resource requirement 116 for executing the one or more services 310. The processing device 302 can, prior to updating the container 108, migrate execution of the one or more services 310 to the second node 102b. The processing device 302 can, subsequent to updating the container 108, migrate execution of the one or more services 310 back to the updated container 108.

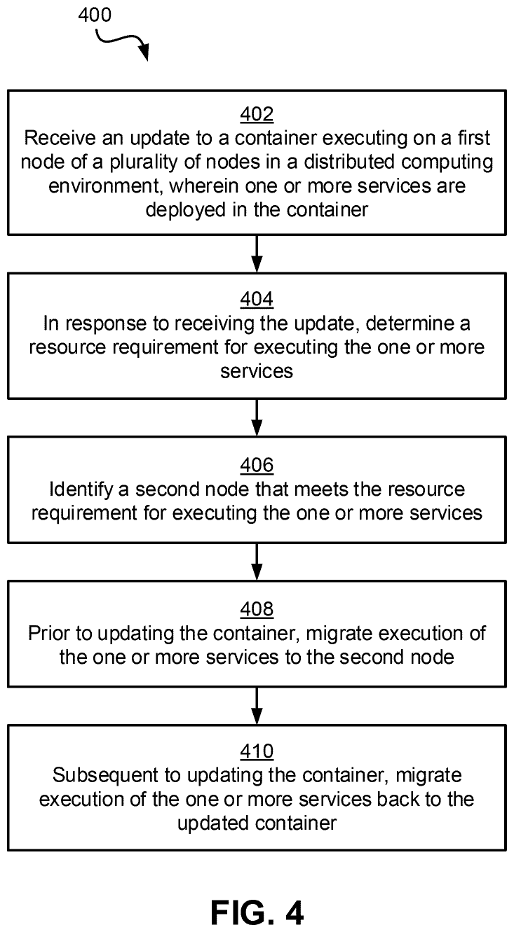

FIG. 4 is a flowchart of an example of a process for implementing container migration for updates in a distributed computing environment, according to some aspects of the present disclosure. In some examples, the processing device 302 can implement some or all of the steps shown in FIG. 3. Additionally, in some examples, the processing device 302 can be executing container orchestration management system 104, the container migration coordinator 106, the distributed computing environment 100, or any suitable component of FIGS. 1-3 to implement some or all of the steps shown in FIG. 4. Other examples can include more steps, fewer steps, different steps, or a different order of the steps than is shown in FIG. 4. The steps of FIG. 4 are discussed below with reference to the components discussed above in relation to FIGS. 1-3.

At block 402, the processing device 302 can receive an update 114 to a container 108 executing on a first node 102a of a plurality of nodes 308 in a distributed computing environment 100. One or more services 310 can be deployed in the container 108. For example, the one or more services 310 may include applications that receive and process requests 126 from a client device 112. Applying the update 114 to the container 108 may involve restarting the container 108, which would cause service interruption for the one or more services 310. Therefore, it may be beneficial to automatically migrate execution of the one or more services 310 to another node in the distributed computing environment 100 in response to receiving the update 114 to prevent service interruption.

At block 404, the processing device 302 can, in response to receiving the update 114, determine a resource requirement 116 for executing the one or more services 310. For example, the processing device 302 may identify the one or more services 310 that are deployed in the container 108, such as by accessing a first specification file 118a for the container 108. The first specification file 118a may specify the one or more services 310. In some examples, the first specification file 118a may also indicate minimum or recommended resource requirements for executing the one or more services 310. The processing device 302 can determine the resource requirement 116 based on the recommendations in the first specification file 118a. The resource requirement 116 may include hardware and software requirements, such as available CPU, RAM, storage, operating systems, software dependencies, libraries, and the like.

In some examples, the processing device 302 may determine the resource requirement 116 by monitoring resource consumption of the container executing the one or more services 310 over time. For example, the processing device 302 may periodically (e.g., at regular intervals, such as hourly, daily, weekly, etc.) measure resource consumption (e.g., CPU usage, RAM, network traffic, and the like). The processing device 302 may in some examples generate a container profile 120 indicating typical resource consumption for the container 108 at particular times. For example, the container profile 120 may indicate that CPU usage may, on average, be higher during business hours than outside of business hours. The processing device 302 may therefore determine the resource requirement 116 based on the time of day, week, etc. of the update and on the container profile 120.

At block 406, the processing device 302 can identify a second node 102b that meets the resource requirement 116 for executing the one or more services 310. For example, the second node 102b may be a node that has the necessary hardware and software requirements to execute the one or more services 310. In some examples, the processing device 302 may identify the second node 102b as meeting the resource requirement 116 by accessing a second specification file 118b for the second node 102b. The second specification file 118b may indicate the available hardware and software resources of the second node 102b. In other examples, the processing device 302 may use other profiling tools to determine that the second node 102b meets the resource requirement 116 for executing the one or more services 310.

In some examples, the processing device 302 may determine that the resource requirement 116 is not met by any single node in the distributed computing environment 100. For example, some nodes may meet hardware requirements but not software requirements or may not have enough storage space. Or, a node may meet software requirements but may have insufficient CPU. In such examples, the processing device 302 may split a workload of the container 108 (e.g., into a first set of services and a second set of services, or any suitable number of sets of services). The workload may be split to accommodate resource availability of the other nodes in the distributed computing environment 100, such that a third node is identified that meets a resource requirement for the first set of services and a fourth node is identified that meets a resource requirement for the second set of services. For example, if a particular node meets software requirements for a first service but has insufficient hardware to execute all three services, the first service may be assigned to the particular node, while the other two services may be assigned to other nodes. In another example where a particular node may have insufficient storage capacity for data structures accessed by the one or more services 310, the data structures may be stored on a separate node than the particular node to which the one or more services 310 are migrated. Any combination of nodes and subsets of the one or more services 310 or their components can be utilized. Additionally or alternatively, the processing device 302 can generate an instance of a cloud node 208 in the distributed computing environment 100 that meets the resource requirement 116 for all of the one or more services 310, or in some examples for some of the one or more services 310.

At block 408, the processing device 302 can, prior to updating the container 108, migrate execution of the one or more services 310 to the second node 102b. Or, in examples where no single node meets the resource requirement 116 for all of the one or more services 310, execution of the one or more services 310 may be migrated to two or more nodes and/or a new instance of a cloud node. In some examples, a new container in which the one or more services 310 are deployed can be generated on the second node 102b. After confirming that the one or more services 310 have successfully been migrated to the second node 102b, the processing device 302 can terminate execution of the one or more services 310 on the first node 102a. And, the processing device 302 can update routing rules 125 to route requests 126 from the client device 112 to the second node 102b instead of the first node 102a. The processing device 302 may store metadata 124 indicating the migration locations for the one or more services 310 and the updated routing rules 125. The processing device 302 can then apply the update 114 to the container 108 on the first node 102a and may restart the first node 102a to finish the update 114.

At block 410, the processing device 302 can, subsequent to updating the container 108, migrate execution of the one or more services 310 back to the updated container 108. In some examples, the processing device 302 may first validate the updated container. For example, the processing device 302 may determine that the updated container 108 meets the resource requirement 116 for executing the one or more services 310. If the updated container 108 does not meet the resource requirement 116, such as by failing to reestablish network connection with the distributed computing environment 100, lacking necessary software layers, etc., the processing device 302 may not migrate execution of the one or more services 310 back to the updated container 108. If the updated container 108 does meet the resource requirement 116, the processing device 302 can then migrate the one or more services 310 back to the updated container 108. For example, the processing device 302 may access the metadata 124 that indicates what components were moved to which locations. The processing device 302 may perform the same migration as before, but in reverse, to migrate the one or more services 310 back to the container 108 on the first node 102a. After validating that the one or more services 310 have been migrated back to the container 108, the processing device 302 can terminate execution of the one or more services 310 on the second node 102b (or any other node to which services were migrated) and can update the routing rules 125 to route requests 126 to the first node 102a.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a non-transitory memory device comprising instructions that are executable by the processing device for causing the processing device to:
receive an update to a container executing on a first node of a plurality of nodes in a distributed computing environment, wherein one or more services are deployed in the container;
in response to receiving the update, determine a resource requirement for executing the one or more services;
identify a second node that meets the resource requirement for executing the one or more services;
prior to updating the container, migrate execution of the one or more services to the second node; and
subsequent to updating the container, migrate execution of the one or more services back to the updated container.

2. The system of claim 1, wherein the non-transitory memory device is further executable by the processing device for causing the processing device to, subsequent to updating the container:
determine that the updated container meets the resource requirement for executing the one or more services; and
migrate execution of the one or more services back to the updated container in response to determining that the updated container meets the resource requirement.

3. The system of claim 1, wherein the non-transitory memory device is further executable by the processing device for causing the processing device to determine the resource requirement for executing the one or more services by:
accessing a specification file for the container;
identifying, based on the specification file, the one or more services deployed in the container; and
determining the resource requirement based on the one or more services.

4. The system of claim 1, wherein the non-transitory memory device is further executable by the processing device for causing the processing device to determine the resource requirement for executing the one or more services by:
monitoring resource consumption of the container executing the one or more services over time.

5. The system of claim 1, wherein the update to the container is a first update to a first container, and wherein the non-transitory memory device is further executable by the processing device for causing the processing device to:
receive a second update to a second container executing on a node of the plurality of nodes in the distributed computing environment, wherein a plurality of services are deployed in the second container;
in response to receiving the second update, determine a second resource requirement for executing the plurality of services; and
determine that the second resource requirement for executing the plurality of services is not met by any node in the plurality of nodes.

6. The system of claim 5, wherein the non-transitory memory device is further executable by the processing device for causing the processing device to, in response to determining that the second resource requirement for executing the plurality of services is not met by any node in the plurality of nodes:
split a workload of the second container into a first set of services and a second set of services;
identify a third node of the plurality of nodes that meets a third resource requirement for the first set of services and a fourth node of the plurality of nodes that meets a fourth resource requirement for the second set of services; and
prior to updating the second container, migrate execution of the first set of services to the third node and the second set of services to the fourth node.

7. The system of claim 5, wherein the non-transitory memory device is further executable by the processing device for causing the processing device to, in response to determining that the second resource requirement for executing the plurality of services is not met by any node in the plurality of nodes:
generate an instance of a cloud node in the distributed computing environment that meets the second resource requirement; and
prior to updating the second container, migrate execution of the plurality of services to the cloud node.

8. A method comprising:
receiving, by a processor, an update to a container executing on a first node of a plurality of nodes in a distributed computing environment, wherein one or more services are deployed in the container;
in response to receiving the update, determining, by the processor, a resource requirement for executing the one or more services;
identifying, by the processor, a second node that meets the resource requirement for executing the one or more services;
prior to updating the container, migrating, by the processor, execution of the one or more services to the second node; and
subsequent to updating the container, migrating, by the processor, execution of the one or more services back to the updated container.

9. The method of claim 8, further comprising, subsequent to updating the container:
determining that the updated container meets the resource requirement for executing the one or more services; and
migrating execution of the one or more services back to the updated container in response to determining that the updated container meets the resource requirement.

10. The method of claim 8, wherein determining the resource requirement for executing the one or more services further comprises:
accessing a specification file for the container;
identifying, based on the specification file, the one or more services deployed in the container; and
determining the resource requirement based on the one or more services.

11. The method of claim 8, wherein determining the resource requirement for executing the one or more services further comprises:
monitoring resource consumption of the container executing the one or more services over time.

12. The method of claim 8, wherein the update to the container is a first update to a first container, and wherein the method further comprises:
receiving a second update to a second container executing on a node of the plurality of nodes in the distributed computing environment, wherein a plurality of services are deployed in the second container;
in response to receiving the second update, determining a second resource requirement for executing the plurality of services; and
determining that the second resource requirement for executing the plurality of services is not met by any node in the plurality of nodes.

13. The method of claim 12, further comprising, in response to determining that the second resource requirement for executing the plurality of services is not met by any node in the plurality of nodes:
splitting a workload of the second container into a first set of services and a second set of services;
identifying a third node of the plurality of nodes that meets a third resource requirement for the first set of services and a fourth node of the plurality of nodes that meets a fourth resource requirement for the second set of services; and
prior to updating the second container, migrating execution of the first set of services to the third node and the second set of services to the fourth node.

14. The method of claim 12, further comprising, in response to determining that the second resource requirement for executing the plurality of services is not met by any node in the plurality of nodes:
generating an instance of a cloud node in the distributed computing environment that meets the second resource requirement; and
prior to updating the second container, migrating execution of the plurality of services to the cloud node.

15. A non-transitory computer-readable medium comprising program code that is executable by a processing device for causing the processing device to:
receive an update to a container executing on a first node of a plurality of nodes in a distributed computing environment, wherein one or more services are deployed in the container;
in response to receiving the update, determine a resource requirement for executing the one or more services;
identify a second node that meets the resource requirement for executing the one or more services;
prior to updating the container, migrate execution of the one or more services to the second node; and
subsequent to updating the container, migrate execution of the one or more services back to the updated container.

16. The non-transitory computer-readable medium of claim 15, further comprising program code that is executable by the processing device for causing the processing device to, subsequent to updating the container:
determine that the updated container meets the resource requirement for executing the one or more services; and
migrate execution of the one or more services back to the updated container in response to determining that the updated container meets the resource requirement.

17. The non-transitory computer-readable medium of claim 15, further comprising program code that is executable by the processing device for causing the processing device to determine the resource requirement for executing the one or more services by:
accessing a specification file for the container;
identifying, based on the specification file, the one or more services deployed in the container; and
determining the resource requirement based on the one or more services.

18. The non-transitory computer-readable medium of claim 15, further comprising program code that is executable by the processing device for causing the processing device to determine the resource requirement for executing the one or more services by:
monitoring resource consumption of the container executing the one or more services over time.

19. The non-transitory computer-readable medium of claim 15, wherein the update to the container is a first update to a first container, and wherein the non-transitory computer-readable medium further comprises program code that is executable by the processing device for causing the processing device to:
receive a second update to a second container executing on a node of the plurality of nodes in the distributed computing environment, wherein a plurality of services are deployed in the second container;
in response to receiving the second update, determine a second resource requirement for executing the plurality of services; and
determine that the second resource requirement for executing the plurality of services is not met by any node in the plurality of nodes.

20. The non-transitory computer-readable medium of claim 19, further comprising program code that is executable by the processing device for causing the processing device to, in response to determining that the second resource requirement for executing the plurality of services is not met by any node in the plurality of nodes:
split a workload of the second container into a first set of services and a second set of services;
identify a third node of the plurality of nodes that meets a third resource requirement for the first set of services and a fourth node of the plurality of nodes that meets a fourth resource requirement for the second set of services; and
prior to updating the second container, migrate execution of the first set of services to the third node and the second set of services to the fourth node.
